(19) United States
(12) Patent Application Publication
(10) Pub. No.: US 2025/0008395 A1
(43) Pub. Date: Jan. 2, 2025

(54) CONTINUOUS WAVEFORM (CW) INTERFERENCE DETECTION AND MITIGATION

(71) Applicant: Cypress Semiconductor Corporation, San Jose, CA (US)

(72) Inventors: Chih-Sheng Sung, Taichung (TW); Hsuchu Huang, Zhubei City (TW)

(73) Assignee: Cypress Semiconductor Corporation, San Jose, CA (US)

(21) Appl. No.: 18/343,670

(22) Filed: Jun. 28, 2023

(51) Int. Cl. H04W 36/06; H04W 36/20; H04W 72/0453; H04W 72/541

(52) U.S. Cl. CPC H04W 36/06; H04W 36/20; H04W 72/0453; H04W 72/541

(57) ABSTRACT

A method includes detecting a radio frequency (RP) interference by detecting a time period within a first detection interval during which there is no transmission opportunity, the time period having a duration that meets a duration threshold. The method further includes switching, during a second detection interval, from a first bandwidth to a second bandwidth.

### TECHNICAL FIELD

This disclosure relates to wireless devices and, more specifically, continuous waveform (CW) interference detection and mitigation.

### BACKGROUND

In scenarios where continuous waveform (CW) interference originates from dedicated short-range communication (DSRC) antennas, such CW interference can cause significant bandwidth reduction and can also completely halt data transfer in Wireless Local Area Networks (WLANs). Such bandwidth reductions and halts in data transfer can be particularly problematic when high-speed data transfer is required. To address this problem, the Dynamic Bandwidth Switch (DBS) was introduced to enable WLAN devices to detect interference (e.g., overlapping basic service sets (OBSS), adjacent channel interference, radio frequency (RF) interference, etc.) and switch operating bandwidth to avoid CW interference. However, current OBSS/interference detection mechanisms are too slow to react and do not always downgrade to the appropriate operating bandwidth in a timely manner (e.g., downgrade happens over multiple detection intervals). This is because, under the current OBSS/interference detection, a WLAN device measures the percentage of time during a detection interval that the WLAN device (e.g., the initiator) and its Basic Service Set (BSS) are either idle (i.e., available for transmission or reception), transmitting, and/or receiving. If the percentage of total idle, transmitting, and/or receiving time falls below a threshold percentage, current OBSS/interference detection indicates that there may be CW interference or other factors limiting the available bandwidth. Thus, if a CW interference does not start at the beginning of a detection interval, it may not be detected unless it covers more than a threshold percentage of the total time during the detection interval during which the WLAN could have been idle, transmitting, and/or receiving, causing the bandwidth downgrade to take place later than necessary. Furthermore, even if the interference covers more than a threshold percentage of the total time during the detection interval during which the WLAN could have been idle, transmitting, and/or receiving and interference is detected earlier, the DBS only downgrades one bandwidth level per detection interval, as there is no information about which frequencies of the operating bandwidth the CW interference is located in. As a result, if CW interference is present in a particular sub-band of the operating bandwidth, it may take several detection intervals for the operating bandwidth to be downgraded far enough to avoid the CW interference. This delay in detecting and downgrading the operating bandwidth can significantly affect the user experience, particularly in scenarios where detection intervals are long (e.g., 500 ms) and where it takes multiple detection intervals to downgrade to the appropriate bandwidth.

### BRIEF DESCRIPTION OF THE DRAWINGS

FIG. 1A is a block diagram of an exemplary wireless local area network (WLAN) system, according to some embodiments.

FIG. 1B is a network diagram of a wireless module and continuous waveform (CW) interference, according to some embodiments.

FIG. 2A is a timing diagram illustrating fast CW interference detection and mitigation, according to some embodiments.

FIG. 2B, included for comparison, is a timing diagram illustrating conventional interference detection and mitigation, according to some embodiments.

FIG. 3A is a timing diagram illustrating interference detection and mitigation by directly downgrading to unaffected bandwidth, according to some embodiments.

FIG. 3B, included for comparison, is a timing diagram illustrating conventional interference detection and mitigation, according to some embodiments.

FIG. 4A is a timing diagram illustrating interference detection and mitigation including fast CW interference detection and direct downgrade to unaffected bandwidth, according to some embodiments.

FIG. 4B, included for comparison, is a timing diagram illustrating conventional interference detection and mitigation, according to some embodiments.

FIG. 5A is a flow diagram of a method of performing fast CW interference detection and mitigation, according to some embodiments.

FIG. 5B is a flow diagram of a method of performing interference detection and mitigation by directly downgrading to an unaffected bandwidth, according to some embodiments.

### DETAILED DESCRIPTION

The following description sets forth numerous specific details, such as examples of specific systems, devices, components, methods, and so forth, in order to provide a good understanding of various embodiments of interference detection and bandwidth switching.

The present disclosure relates to a method and system for continuous waveform (CW) interference detection and mitigation in wireless networks, e.g., wireless local area networks (WLANs).

In scenarios where continuous waveform (CW) interference originates from dedicated short-range communication (DSRC) antennas, such CW interference can cause significant bandwidth reduction and can also completely halt data transfer in Wireless Local Area Networks (WLANs). Such bandwidth reductions and halts in data transfer can be particularly problematic when high-speed data transfer is required.

Carrier Sense Multiple Access with Collision Avoidance (CSMA/CA) is a protocol used in WLAN devices to avoid collisions when transmitting data. CSMA/CA is a media access control (MAC) protocol used by wireless networks, which detects interference independently of dynamic bandwidth switching (DBS), often causing data transmission to halt before DBS can mitigate interference. CSMA/CA uses carrier sensing to detect whether a wireless medium is idle or busy before transmitting data. When a CW interference signal is detected, CSMA/CA causes a WLAN device to stop transmitting until the interference is gone or the bandwidth is downgraded to a sub-band unaffected by the interference. CSMA/CA detects interference when, for example, CW interference originating from a DSRC antenna is detected that is above a threshold (e.g., −62 dBm) and causes transmission to stop. This means that while such interference persists, the WLAN device has no transmission opportunity. Transmission opportunity refers to channel idle time when the WLAN device is neither transmitting, receiving, nor being interfered with. To address this problem, DBS was introduced to enable WLAN modules to detect interference (e.g., overlapping basic service sets (OBSS), adjacent channel interference, radio frequency (RF) interference, etc.) and switch operating bandwidth to avoid CW interference.

However, current OBSS/interference detection mechanisms are too slow to react and do not always downgrade to the appropriate operating bandwidth in a timely manner. This is because, under the current OBSS/interference detection, a WLAN device measures the percentage of time during a detection interval that the WLAN device (e.g., the initiator) and its Basic Service Set (BSS) are either idle (i.e., available for transmission or reception), transmitting, and/or receiving. If the percentage of total idle, transmitting, and/or receiving time falls below a threshold percentage, current OBSS/interference detection indicates that there may be CW interference or other factors limiting the available bandwidth. Thus, if a CW interference does not start at the beginning of a detection interval, it may not be detected unless it covers more than a threshold percentage of the total time during the detection interval during which the WLAN could have been idle, transmitting, and/or receiving, causing the bandwidth downgrade to take place later than necessary.

Using conventional methods, in order to detect interference, the interference must occupy a significant amount of the detection interval (e.g., causing the total time a WLAN device is either idle, transmitting, and/or receiving to be less than a threshold percentage) during the detection interval, or it will not be detected even though it is present and causing a halt in transmission. Furthermore, even if the interference covers more than a threshold percentage of the total time during the detection interval during which the WLAN could have been idle, transmitting, and/or receiving and interference is detected earlier, the DBS only downgrades one bandwidth level per detection interval, as there is no information about which frequencies of the operating bandwidth the CW interference is located in. As a result, if CW interference is present in a particular sub-band of the operating bandwidth, it may take several detection intervals for the operating bandwidth to be downgraded far enough to avoid the interference. This delay in detecting and downgrading the operating bandwidth can significantly affect the user experience, particularly in scenarios where detection intervals are long (e.g., 500 ms) and where it takes multiple detection intervals to downgrade to the appropriate bandwidth.

In some examples, under current CW interference detection and mitigation mechanisms, detecting CW interference and downgrading to the appropriate unaffected bandwidth can take one detection cycle per bandwidth level downgrade (e.g., 80 Mhz to 40 MHz, 40 MHz to 20 MHz, and so on) to be completed. Downgrading one bandwidth level means downgrading to half of current bandwidth (e.g., from 80 MHz to 40 MHz or 40 MHz to 20 MHz). For example, a WLAN device operating at 80 MHz that experiences CW interference on the 40 MHz sub-band would take at least two detection intervals to downgrade to the appropriate unaffected bandwidth (i.e., 20 MHz).

Therefore, there is a need for a solution that can detect CW interference earlier (even when the total time spent by a WLAN in an idle state, transmitting and/or receiving during the detection interval is longer) and downgrade the operating bandwidth to the necessary sub-band quickly (i.e., over fewer detection intervals). To resolve these and other deficiencies and improve the limitation of current CW interference detection and mitigation, the present disclosure sets forth an improved method and system for CW interference detection and mitigation in wireless networks.

In at least some embodiments, the present disclosure provides a method for CW interference detection and mitigation in a wireless network which can significantly improve the user experience in scenarios where interference is present.

By using different criteria for CW interference detection and incorporating information about which frequency sub-bands of the operating bandwidth the CW interference is located in, the present disclosure provides earlier CW interference detection and quicker mitigation (i.e., downgrading to sub-bands unaffected by CW interference). Thus, the present disclosure improves upon the limitation inherent in the current CW interference detection and mitigation mechanisms.

Thus, in at least some embodiments, a method is disclosed for CW interference detection and mitigation. The method includes detecting an RF interference by detecting a time period within a first detection interval during which there is no Transmission opportunity (time during which the channel is not idle, e.g., WLAN device is either transmitting, receiving, or CSMA/CA halts transmission/reception due to CW interference) the time period having a duration that meets a duration threshold. The method further includes switching, during a second detection interval, from a first bandwidth to a second bandwidth. In some embodiments, the first and second detection intervals are contiguous, and the first detection interval precedes the second detection interval. In some embodiments, the first bandwidth includes multiple sub-bands, and the second bandwidth is a subset of the multiple sub-bands of the first bandwidth. In some embodiments, the RF interference is a CW interference.

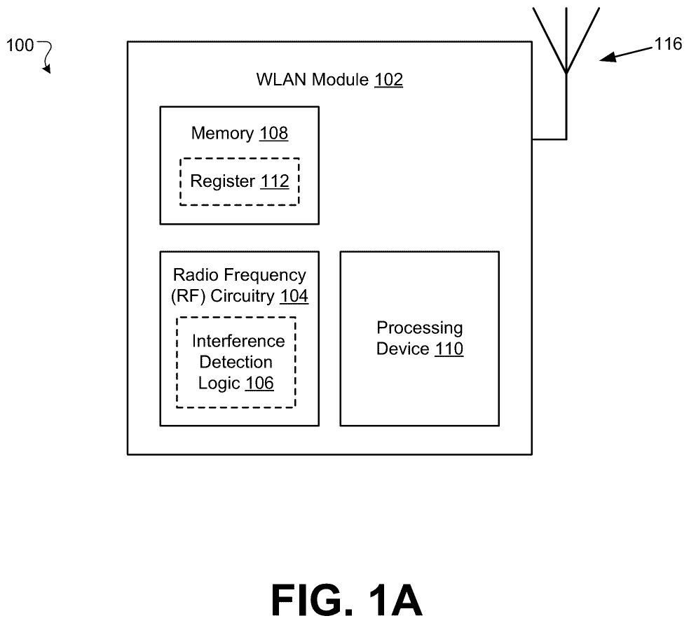

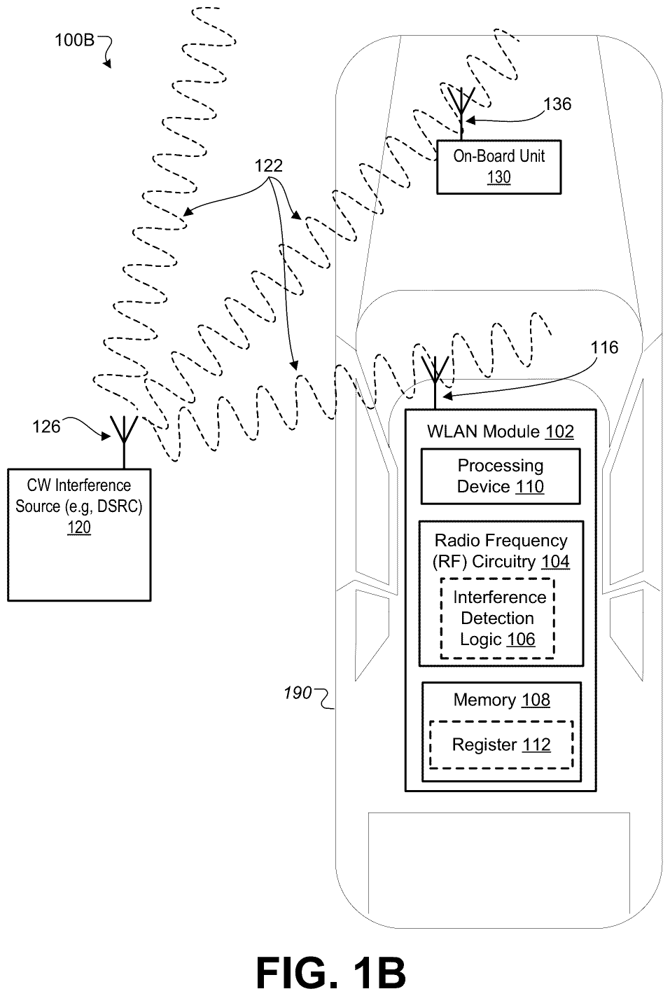

In some embodiments, the method may further include determining whether an interference energy level for the second bandwidth meets a threshold interference energy level. The method may further include, in response to determining that the interference energy level for the second bandwidth does not meet the threshold interference energy level, switching from the first bandwidth to the second bandwidth during the second detection interval. Additional embodiments and variations in implementation will be discussed in detail with reference to FIGS. 1-5.

The present disclosure includes a number of advantages, including faster detection of CW interference and faster downgrading of operating bandwidth to the appropriate unaffected bandwidth. This approach detects CW interference even when the interference is of a short duration and starts at the end of the first detection interval, eliminating delays in triggering downgrading the operating bandwidth to the appropriate unaffected bandwidth. Further, this approach provides downgrading the operating bandwidth directly (i.e., within one detection interval) to the appropriate unaffected bandwidth regardless of which sub-band the CW interference is located on, eliminating data transmission halts and zero-stalls in data transmission (i.e., intervals during which no data is transmitted and/or received). Additional advantages will be apparent to those skilled in the art of modern wireless technologies. It should be noted that the present disclosure is not limited to applications in WLAN technologies but may be implemented with any wireless protocol (e.g., Bluetooth, Personal Area Network (PAN), Long-Term Evolution (LTE), Near Field Communication (NFC), and/or the like).

FIG. 1A is a block diagram of an exemplary WLAN system, according to some embodiments. In some embodiments, the WLAN system 100 (hereinafter referred to as “system 100”) includes a wireless module (WLAN module 102), RF circuitry 104, a memory 108, and a processing device 110. In some embodiments, WLAN module 102 operates at a certain frequency (e.g., 5 GHz) and on an operating bandwidth made up of multiple sub-bands. For example, a WLAN module may operate on a bandwidth of 80 MHz, including sub-bands 0 MHz to 20 MHz, 20 MHz to 40 MHz, 40 MHz to 60 MHz, and 60 MHz to 80 MHz. At times the operating bandwidth of WLAN module 102 may be reduced to avoid CW interference present in one or more of the sub-bands.

In some embodiments, system 100 includes a register 112 within memory 108. In some embodiments, system 100 includes interference detection logic 106.

In some embodiments, RF circuitry 104 may include an antenna 116. In some embodiments, antenna 116 sends and receives wireless signals. Antenna 116 may also receive signals that interfere with the operation of WLAN module 102. In some embodiments, RF circuitry 104 is coupled to processing device 110 and antenna 116. In some embodiments, RF circuitry 104 transmits and receives signals in a specific frequency band (i.e., the operating bandwidth). RF circuitry may operate in a specific frequency band (e.g., 2.4 GHz, 5 GHz, 6 GHz, etc.).

In some embodiments, interference detection logic 106 may be logic that, when executed, detects interfering signals (e.g., CW interference) received by antenna 116. In some embodiments, interference detection logic 106 may be firmware embedded in RF circuitry 104. In some embodiments, interference detection logic 106 may be stored in memory 108 as instructions to be executed by processing device 110. In some embodiments, such instructions may be written into specific memory locations or hardware registers (e.g., register 112) in a non-volatile memory (e.g., memory 108).

In some embodiments, interference detection logic 106 implemented as hardware, and may detect interfering signals (e.g., CW interference) received by antenna 116. In some embodiments, interference detection logic 106 may be hardware (e.g., part of RF circuitry 104, coupled to RF circuitry 104, etc.). In some embodiments, interference detection logic 106 may be hardware that is coupled to processing device 110.

In some embodiments, processing device 110 may be coupled to RF circuitry 104. In some embodiments, processing device 110 may switch the RF circuitry 104 from operating with a first bandwidth to a second bandwidth. In some embodiments, processing device 110 may determine the interference energy level (e.g., stored in register 112) for a bandwidth (e.g., a sub-band of the operating bandwidth). Processing device 110 may communicate with RF circuitry 104. Processing device 110 may send and receive data from RF circuitry. Processing device 110 may store data in memory 108 and retrieve that stored data and other data from memory 108. Processing device 110 may also execute instructions taken from memory 108. Processing device 110 may analyze data received from memory 108 and/or other components (e.g., RF circuitry, interference detection logic 106, etc.) of WLAN module 102.

In an example of operation, WLAN module 102 detects an RF interference by detecting a time period within a first detection interval during which there is no transmission opportunity (i.e., the channel is not idle, e.g., WLAN device is either transmitting, receiving, or CSMA/CA has halted transmission/reception due to CW interference). In some examples, when the power level of a CW interference is above −62 dBm, CSMA/CA causes transmission to stop. The time period has a corresponding duration, and processing device 110 determines whether the duration of the time period meets a duration threshold (e.g., 20 percent of detection interval duration—e.g., 100 ms for a 500 ms detection interval). RF circuitry 104 is operating at a certain frequency, e.g., 5 GHz, on a bandwidth of, e.g., 80 MHz. Processing device 110 determines whether each subset of the operating bandwidth (e.g., 0 MHz to 20 MHz, 20 MHz to 40 MHz, 40 MHz to 60 MHz, and 60 MHz to 80 MHz) has an interference energy level (e.g., DSRC signal power) that meets a threshold interference energy level (e.g., DSRC signal above −62 dBm). For example, processing device 110 may determine that sub-band 20 MHz to 40 MHz has an interference energy level (e.g., DSRC signal power) that meets a threshold interference energy level (e.g., DSRC signal above −62 dBm). Processing device 110 may also determine that the interference energy levels for 0 MHz to 20 MHz and 60 MHz to 80 MHz do not meet the threshold interference energy level (e.g., DSRC signal above-62 dBm). In response to determining that the interference energy level for sub-band 0 MHz to 20 MHz does not meet the threshold interference energy level, processing device 110 downgrades the operating bandwidth to the sub-band or sub-bands unaffected by the interference (e.g., 0 MHz to 20 MHz) and transmission resumes. It is important to note that although the sub-band 60 MHz to 80 MHz is unaffected by the interference, it may be necessary to downgrade to a bandwidth that does not include sub-band 60 MHz to 80 MHz to avoid interference on sub-band 20 MHz to 40 MHz.

FIG. 1B is a network diagram of a wireless module and CW interference, according to some embodiments. In some embodiments, the network 100B includes a WLAN module 102. In some embodiments, WLAN module 102 of FIG. 1B may be the same or similar to WLAN module 102 of FIG. 1A and may include the same and/or similar components. In some embodiments, WLAN module 102 may be coupled to a vehicle 190 and may be part of an infotainment system of vehicle 190. In some embodiments, the network 100B includes a CW interference source 120 having an antenna 126.

In some embodiments, CW interference may originate from a DSRC source, such as a DSRC antenna (e.g., antenna 126), or from other sources, including radio frequency identification (RFID) readers, Wi-Fi devices, Bluetooth devices, radar systems, microwave ovens, satellite communication systems and/or the like. In some embodiments, a CW interference source transmits CW interference signals 122 via antenna 126. In some embodiments, CW interference signals 122 may be received by antenna 116 of WLAN module 102 and may interfere with operation of WLAN module 102, however, CW interference signals 122 may be intended for an on-board unit (OBU) 130 coupled to vehicle 190. In some embodiments, OBU 130 has an antenna 136 for receiving CW interference signals 122. In some embodiments, OBU 130 may be part of a toll road and/or bridge system, the CW interference source 120 being a DSRC device sending CW interference signals 122 via antenna 126 to OBU 130 on vehicle 190 as it crosses a toll bridge or uses a toll road. OBU 130 may be used to verify and collect the toll, providing a seamless and efficient toll collection process for drivers and toll authorities alike. As mentioned above, a WLAN device (e.g., WLAN module 102) may experience CW interference (e.g., CW interference 122) from such an interference source as a toll system, including a DSRC antenna and an OBU. In some embodiments, such interference causes the operation (e.g., transmit/receive functions) of a WLAN to stop until the interference subsides (e.g., because vehicle 190 continues past the toll system), or the WLAN module downgrades to the appropriate unaffected sub-band of the original operating bandwidth. This may occur as vehicle 190 approaches a toll system and comes close to CW interference source 120.

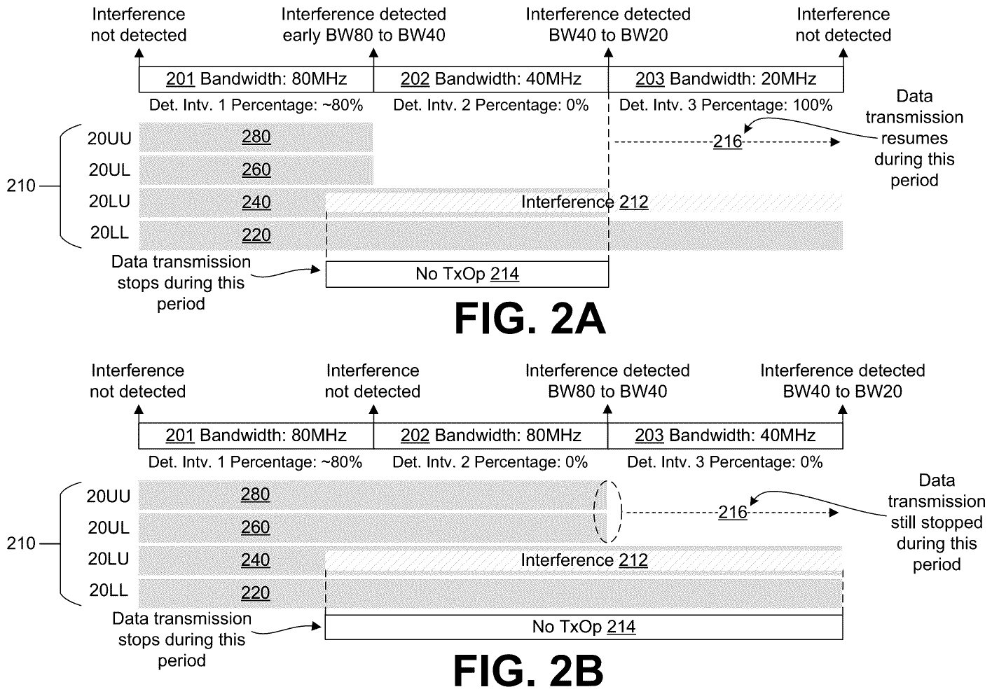

FIG. 2A is a timing diagram illustrating fast CW interference detection and mitigation, according to some embodiments.

In some embodiments, the operating bandwidth 210 of a WLAN device (e.g., WLAN module 102 of FIG. 1A and/or 1B) is divided into sub-bands. For example, operating bandwidth 210 may be 80 MHz and be divided into sub-bands 20UU, 20UL, 20LU, and 20LL. In some embodiments, 20LL ranges from 0 MHz to 20 MHz (sub-band 220), 20 LU ranges from 20 MHz to 40 MHz (sub-band 240), 20UL ranges from 40 MHz to 60 MHz (sub-band 260), and 20UU ranges from 60 MHz to 80 MHz (sub-band 280). In some embodiments, before interference 212 is detected, the WLAN device operates on an operating bandwidth that includes sub-bands 220, 240, 260, and 280.

In some embodiments, detection intervals are intervals during which the RF circuitry of a WLAN device scans sub-bands 220, 240, 260, and 280 to detect any interference that may be present. In some embodiments, the RF circuitry of the WLAN device also transmits, receives, and/or is idle during a detection interval. The processing device of the WLAN device may initiate a scan by instructing the RF circuitry to switch to a specific frequency band and then wait for a response. In some embodiments, detection of a WLAN packet (e.g., via clear channel assessment) and/or interference (e.g., via energy detection) on each sub-band of the operating bandwidth (e.g., 80 Mhz) can be done without an additional scan and/or response. The RF circuitry may receive signals from other wireless networks (e.g., interference signals). The RF circuitry may send signal information (e.g., an interference energy level) to the processing device, which analyzes the information to determine the presence, strength, and/or duration of the interference. Based on the analysis, the processor may choose to either continue operation on the current bandwidth or downgrade to a sub-band or sub-bands that have less interference. The detection interval continues for a predetermined period (e.g., 500 ms), during which the RF circuitry and processing device work together to detect and analyze wireless network signals (e.g., interference signals) in the surrounding environment.

In some embodiments, detection intervals are intervals during which the interference detection logic of a WLAN device may be executed to scan sub-bands 220, 240, 260, and 280 to detect any interference that may be present.

In some embodiments, during detection interval 201, a WLAN device is operating on a bandwidth of 80 MHz. Interference 212 begins near the end of detection interval 201. In some embodiments, the interference causes there to be no transmission opportunity for a time period.

The presence of the interference causes the channel to not be idle (i.e., there is no transmission opportunity), even though CSMA/CA has halted transmission/reception due to CW interference. In the presence of interference, there is no transmission opportunity (transmission opportunity is equal to zero) because CSMA/CA has halted transmission/reception due to CW interference, and the interference meets a duration threshold (e.g., lasts for more than 20 percent of detection interval duration—e.g., 100 ms for a 500 ms detection interval). In some embodiments, Interference 212 is present in sub-band 240 of the operating bandwidth. When interference 212 begins, CSMA/CA detects the interference 212 and causes transmission and/or reception of data to stop. This is shown by the no transmission opportunity period 214, during which the transmission opportunity for the wireless device is zero (i.e., there is no transmission opportunity due to CSMA/CA detecting interference).

In some embodiments, a time period within detection interval 201 during which there is transmission opportunity refers to a time period where the channel is idle (i.e., there is no transmit activity, receive activity, or interference). In some embodiments, a time period where the transmission opportunity is equal to zero correlates to CW interference being present on the channel, causing the WLAN device to stop transmitting and receiving due to CSMA/CA. When no interference is present, one consecutive period of channel busy time typically does not exceed a threshold duration (e.g., 20 percent of detection interval duration—e.g., 100 ms for a 500 ms detection interval). Periods of no transmission opportunity (i.e., transmission opportunity is equal to zero) may be referred to as channel busy time (i.e., when the WLAN device is neither transmitting, receiving, nor being interfered with). It should be noted that under normal operation, in the absence of interference, the total time that the transmission opportunity is equal to zero during a detection interval may exceed a threshold duration. However, that total includes shorter non-consecutive time periods that are each no longer than the threshold duration. For example, WLAN packet transmission can typically be completed in less than 10 milliseconds (e.g., 5-6 milliseconds).

For example, the transmission or reception of a single data frame typically takes less than a threshold duration (e.g., 20 percent of detection interval duration—e.g., 100 ms for a 500 ms detection interval). Further, there are small intervals (inter-frame spaces) between data frames where the wireless device listens for other transmissions or other events on the channel. Therefore, even though a WLAN device may be transmitting or receiving, for example, data frames for 400 ms of a 500 ms detection interval, those 400 ms may include many shorter time periods for sending individual data frames that do not meet the duration threshold (e.g., less than 20 percent of detection interval duration—e.g., 100 ms for a 500 ms detection interval). Further, the time periods for sending data frames are interspaced with IFSs, and thus the channel busy time does not exceed 20 percent of detection interval duration (e.g., 100 ms for a 500 ms detection interval, 20 ms for a 100 ms detection interval, etc.) in any one period (i.e., the transmission opportunity does not equal zero for more than 20 percent of detection interval duration at a time).

In some embodiments, by using fast CW interference detection, a wireless device (e.g., WLAN module 102 of FIG. 1A or 1B) detects the interference by determining that a no transmission opportunity period lasts for at least a threshold amount of time (e.g., 20 percent of detection interval duration—e.g., 100 ms for a 500 ms detection interval) during a detection interval. In the present example, interference 212 lasts at least 20 percent of detection interval duration (e.g., 100 ms for a 500 ms detection interval) during the detection interval 201, causing the transmission opportunity to be equal to zero for the same at least 20 percent of detection interval duration and triggering detection of interference and downgrading bandwidth during the next detection interval (detection interval 202). At the beginning of detection interval 202, the operating bandwidth is downgraded to 40 MHz (i.e., sub-bands 220 and 240). Again, interference 212 is detected because a no transmission opportunity period lasts at least 20 percent of detection interval duration within detection interval 202, triggering detection of interference and downgrading of bandwidth during the next detection interval (detection interval 203). At the beginning of detection interval 203, the operating bandwidth is downgraded to 20 MHz (i.e., sub-band 220). During time period 216, data transmission resumes because CSMA/CA detects no interference causing there to again be transmitted opportunity for the entire duration of detection interval 203. No further bandwidth downgrading is necessary.

FIG. 2B, included for comparison, is a timing diagram illustrating conventional interference detection and mitigation, according to some embodiments. The present disclosure outperforms conventional interference detection Under the same conditions as FIG. 2A.

For example, during detection interval 201, interference 212 is present, causing CSMA/CA to trigger a halt in transmission and reception for the WLAN device. However, conventional interference detection uses different criteria to detect interference 212. For conventional interference detection, the condition to trigger bandwidth downgrade is met when the total channel idle and data transmission time in the same BSS within the detection interval is below a given percentage. TxOp is the transmission opportunity or the amount of time that the medium is idle (i.e., no transmission, reception, or interference on the medium) during a sample duration (e.g., detection interval). For example, if the time during which the WLAN device is idle, transmitting, and/or receiving is less than a threshold percentage within a sampling period (detection interval), then downgrading is triggered. However, if the total idle, transmitting, and/or receiving is more than the threshold percentage, no downgrade is triggered, and the interference persists.

In this example, a downgrade is not triggered until the end of detection interval 202 when it is determined that the WLAN device was idle, transmitting, and/or receiving for less than the threshold percentage during detection interval 202. Bandwidth downgrading finally begins at the beginning of detection interval 203, but during time period 216, data transmission is still stopped because one more downgrade needs to be performed before the appropriate unaffected bandwidth is reached (i.e., 20 MHz, sub-band 220).

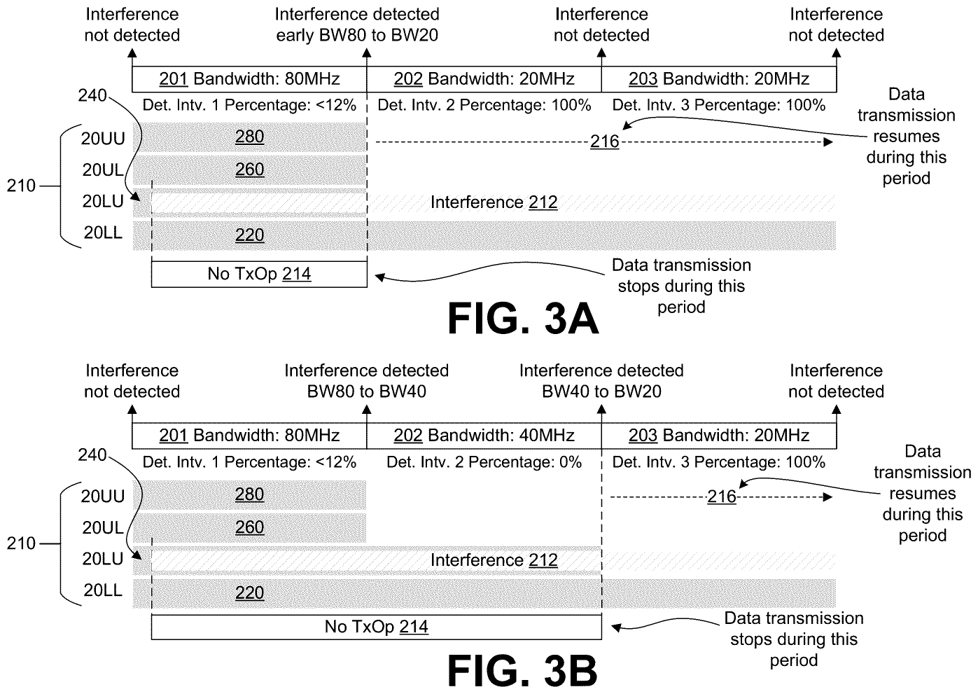

FIG. 3A is a timing diagram illustrating interference detection and mitigation by directly downgrading to unaffected bandwidth, according to some embodiments. In some embodiments, the operating bandwidth 210 of a WLAN device (e.g., WLAN module 102) is divided into sub-bands. For example, operating bandwidth 210 may be 80 MHz and be divided into sub-bands 20UU, 20UL, 20LU, and 20LL. In some embodiments, 20LL ranges from 0 MHz to 20 MHz (sub-band 220), 20 LU ranges from 20 MHz to 40 MHz (sub-band 240), 20UL ranges from 40 MHz to 60 MHz (sub-band 260), and 20UU ranges from 60 MHz to 80 MHz (sub-band 280). In some embodiments, before interference 212 is detected, the WLAN device operates on an operating bandwidth of 80 Mhz, including sub-bands 220, 240, 260, and 280.

In some embodiments, detection intervals are intervals during which the RF circuitry of a WLAN device scans sub-bands 220, 240, 260, and 280 to detect any interference that may be present. In some embodiments, the RF circuitry of the WLAN device also transmits, receives, and/or is idle during a detection interval. The processing device of the WLAN device may initiate a scan by instructing the RF circuitry to switch to a specific frequency band and then wait for a response. In some embodiments, detection of a WLAN packet (e.g., via clear channel assessment) and/or interference (e.g., via energy detection) on each sub-band of the operating bandwidth (e.g., 80 MHz) can be done without an additional scan and/or response. The RF circuitry may receive signals from other wireless networks (e.g., interference signals). The RF circuitry may send signal information (e.g., an interference energy level) to the processing device, which analyzes the information to determine the presence, strength, and/or duration of the interference. Based on the analysis, the processor may choose to either continue operation on the current bandwidth or downgrade to a sub-band or sub-bands that have less interference. The detection interval continues for a predetermined period (e.g., 500 ms), during which the RF circuitry and processing device work together to detect and analyze wireless network signals (e.g., interference signals) in the surrounding environment.

In some embodiments, detection intervals are intervals during which the interference detection logic of a WLAN device maybe be executed to scan sub-bands 220, 240, 260, and 280 to detect any interference that may be present. In some embodiments, during detection interval 201, a WLAN device is operating on a bandwidth of 80 MHz.

Interference 212 begins near the beginning of detection interval 201 and occupies more than a threshold percentage of the detection interval 201 (i.e., the WLAN device was idle, transmitting, and/or receiving for less than a threshold percentage of the detection interval). Interference 212 is present in sub-band 240 of the operating bandwidth. When interference 212 begins, CSMA/CA detects the interference 212 and causes transmission and/or reception of data to stop. This is shown by the no transmission opportunity period 214, during which the transmission opportunity for the wireless device is equal to zero (i.e., there is no transmission opportunity due to CSMA/CA detecting interference).

In some embodiments, by directly downgrading to the unaffected bandwidth, a wireless device avoids prolonged interference by determining which frequency sub-band has an elevated interference energy level and downgrading to a sub-band below the sub-band with the elevated interference energy level. In some embodiments, a WLAN device may determine which frequency sub-band has an elevated interference energy level as well as which sub-bands do not have an elevated interference energy level. The WLAN device may downgrade to a sub-band without an elevated interference energy level that is below the sub-band with the elevated interference energy level.

In the present example, interference 212 is detected during detection interval 201, triggering downgrading of bandwidth during the next detection interval (detection interval 202). The WLAN device determines, by checking a register where interference energy levels are stored, that sub-band 240 has an elevated interference energy level. In some embodiments, the WLAN device may also determine that sub-band 220 does not have an elevated interference energy level by checking a register where interference energy levels are stored. At the beginning of detection interval 202, the WLAN device downgrades the operating bandwidth directly to 20 MHz (i.e., sub-band 220) because 20 MHz is the next sub-band below the affected 40 MHz sub-band and sub-band 220 is unaffected by the interference. During time period 216 data transmission resumes because CSMA/CA no longer detects interference and thus there is transmission opportunity for the entire duration of detection interval 202 and 203. No further bandwidth downgrading is necessary.

FIG. 3B, included for comparison, is a timing diagram illustrating conventional interference detection and mitigation, according to some embodiments. The present disclosure outperforms conventional interference mitigation under the same conditions as FIG. 3A.

For example, during detection interval 201, interference 212 is present, causing CSMA/CA to trigger a halt in transmission and reception for the WLAN device.

Interference 212 begins near the beginning of detection interval 201 and occupies more than a threshold percentage of the detection interval 201 (i.e., the WLAN device was idle, transmitting, and/or receiving for less than a threshold percentage of the detection interval). Interference 212 is present in sub-band 240 of the operating bandwidth. When interference 212 begins, CSMA/CA detects the interference 212 and causes transmission and/or reception of data to stop. This is shown by the no transmission opportunity period 214, during which the transmission opportunity for the wireless device is equal to zero (i.e., there is no transmission opportunity due to CSMA/CA detecting interference). However, even though the interference is detected at the end of the detection interval 201 downgrading takes significantly longer than the present disclosure because conventional interference mitigation mechanisms only downgrade one bandwidth level per detection interval where interference is detected. In some embodiments, downgrading one bandwidth level means downgrading to half of current bandwidth (e.g., from 80 MHz to 40 MHz or 40 MHz to 20 MHz).

In this example, a downgrade is triggered and the end of detection interval 201, but the bandwidth is downgraded only to the 40 MHz sub-band (i.e., sub-bands 220 and 240) where the interference is still present (i.e., in sub-band 240). Bandwidth downgrading must be performed again at the beginning of detection interval 203. During time period 216 data transmission is resumed, however resuming transmission takes longer than techniques used in the present disclosure. As illustrated, the no transmission opportunity period 214 of FIG. 3B is significantly longer than the no transmission opportunity period 214 of FIG. 3A because conventional mitigation takes longer to downgrade to the appropriate unaffected bandwidth (e.g., sub-band 220) to avoid interference 212.

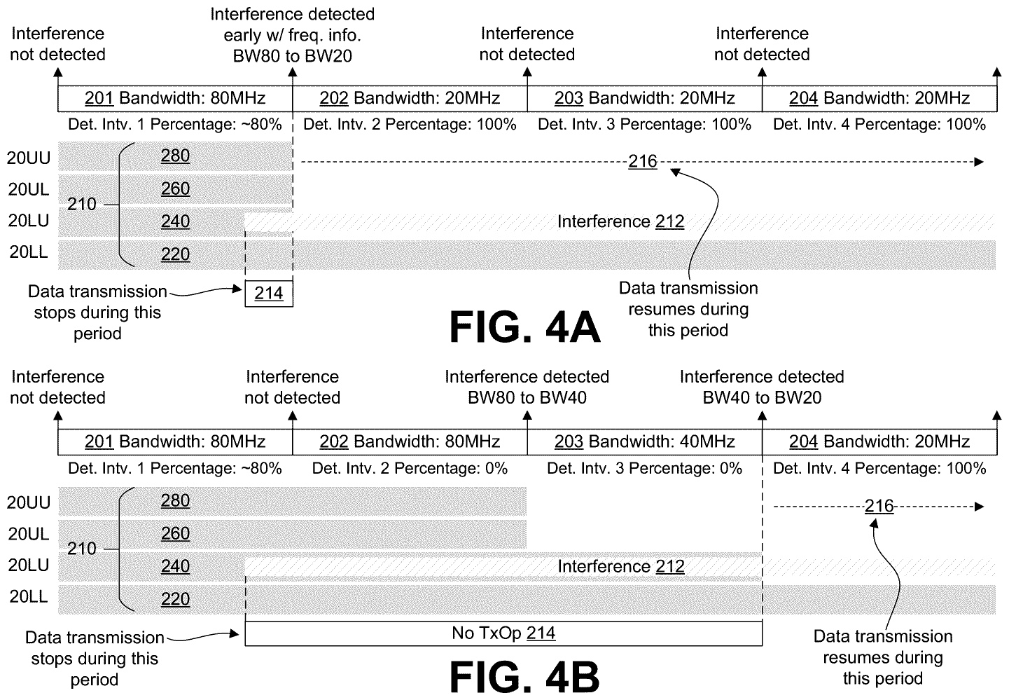

FIG. 4A is a timing diagram illustrating interference detection and mitigation including fast CW interference detection and direct downgrade to unaffected bandwidth, according to some embodiments. In some embodiments, the operating bandwidth 210 of a WLAN device (e.g., WLAN module 102) is divided into sub-bands. For example, operating bandwidth 210 may be 80 MHz and be divided into sub-bands 20UU, 20UL, 20LU, and 20LL. In some embodiments, 20LL ranges from 0 MHz to 20 MHz (sub-band 220), 20 LU ranges from 20 MHz to 40 MHz (sub-band 240), 20UL ranges from 40 MHz to 60 MHz (sub-band 260), and 20UU ranges from 60 MHz to 80 MHz (sub-band 280). In some embodiments, before interference 212 is detected, the WLAN device operates on an operating bandwidth of 80 MHz, including sub-bands 220, 240, 260, and 280.

In some embodiments, detection intervals are intervals during which the RF circuitry of a WLAN device scans sub-bands 220, 240, 260, and 280 to detect any interference that may be present. In some embodiments, the RF circuitry of the WLAN device also transmits, receives, and/or is idle during a detection interval. The processing device of the WLAN device may initiate a scan by instructing the RF circuitry to switch to a specific frequency band and then wait for a response. In some embodiments, detection of a WLAN packet (e.g., via clear channel assessment) and/or interference (e.g., via energy detection) on each sub-band of the operating bandwidth (e.g., 80 MHz) can be done without an additional scan and/or response. The RF circuitry may receive signals from other wireless networks (e.g., interference signals). The RF circuitry may send signal information (e.g., an interference energy level) to the processing device, which analyzes the information to determine the presence, strength, and/or duration of the interference. Based on the analysis, the processor may choose to either continue operation on the current bandwidth or downgrade to a sub-band or sub-bands that have less interference. The detection interval continues for a predetermined period (e.g., 500 ms), during which the RF circuitry and processing device work together to detect and analyze wireless network signals (e.g., interference signals) in the surrounding environment.

In some embodiments, detection intervals are intervals during which the interference detection logic of a WLAN device maybe be executed to scan sub-bands 220, 240, 260, and 280 to detect any interference that may be present.

In some embodiments, during detection interval 201, a WLAN device is operating on a bandwidth of 80 MHz. Interference 212 begins near the end of detection interval 201. In some embodiments, the interference causes there to be no transmission opportunity for a time period.

The presence of the interference causes the channel to not be idle (i.e., there is no transmission opportunity), even though CSMA/CA has halted transmission/reception due to CW interference. In this case of interference, the transmission opportunity is equal to zero because CSMA/CA has halted transmission/reception due to CW interference, and the interference meets a duration threshold (e.g., lasts for more than 20 percent of detection interval duration—e.g., 100 ms for a 500 ms detection interval). In some embodiments, Interference 212 is present in sub-band 240 of the operating bandwidth. When interference 212 begins, CSMA/CA detects the interference 212 and causes transmission and/or reception of data to stop. This is shown by the no transmission opportunity period 214, during which the transmission opportunity for the wireless device is zero (i.e., there is no transmission opportunity due to CSMA/CA detecting interference).

In some embodiments, a time period within detection interval 201 during which there is transmission opportunity (i.e., there is opportunity to transmit and/or receive) refers to a time period where the channel is idle (i.e., there is no transmit activity, receive activity, or interference). In some embodiments, a time period where transmission opportunity is equal to zero correlates to CW interference being present on the channel, causing the WLAN device to stop transmitting and receiving due to CSMA/CA. When no interference is present, one consecutive period of channel busy time typically does not exceed a threshold duration (e.g., 20 percent of detection interval duration—e.g., 100 ms for a 500 ms detection interval). It should be noted that under normal operation, in the absence of interference, the total time that transmission opportunity is equal to zero during a detection interval may exceed a threshold duration. However, that total includes shorter non-consecutive time periods that are each no longer than the threshold duration. For example, WLAN packet transmission can typically be completed in less than 10 milliseconds (e.g., 5-6 milliseconds).

For example, the transmission or reception of a single data frame typically takes less than a threshold duration (e.g., 20 percent of detection interval duration—e.g., 100 ms for a 500 ms detection interval). Further, there are small intervals (inter-frame spaces) in between data frames where the wireless device is listening for other transmissions or other events on the channel. Therefore, even though a WLAN device may be transmitting or receiving, for example, data frames for 400 ms of a 500 ms detection interval, those 400 ms may include many shorter time periods for sending individual data frames that do not meet the duration threshold (e.g., less than 20 percent of detection interval duration—e.g., 100 ms for a 500 ms detection interval). Further, the time periods for sending data frames are interspaced with IFSs and thus the channel busy time does not exceed 20 percent of detection interval duration (e.g., 100 ms for a 500 ms detection interval) in any one period (i.e., transmission opportunity does not equal zero for more than 20 percent of detection interval duration at a time).

In some embodiments, by using fast CW interference detection, a wireless device (e.g., WLAN module 102 of FIG. 1A or 1B) detects the interference by determining that a no transmission opportunity period lasts for at least a threshold amount of time (e.g., 20 percent of detection interval duration—e.g., 100 ms for a 500 ms detection interval) during a detection interval (e.g., detection interval 201). In the present example, interference 212 lasts at least 20 percent of detection interval duration during the detection interval 201, causing the transmission opportunity to be equal to zero for the same at least 20 percent of detection interval duration and triggering detection of interference and downgrading of bandwidth during the next detection interval (detection interval 202).

Further, the WLAN device determines, by checking a register where interference energy levels are stored, that sub-band 240 has an elevated interference energy level. In some embodiments, the WLAN device may also determine that sub-band 220 does not have an elevated interference energy level by checking a register where interference energy levels are stored. At the beginning of detection interval 202, the WLAN device downgrades the operating bandwidth directly to 20 MHz (i.e., sub-band 220) because 20 MHz is the next sub-band below the affected 40 MHz sub-band and sub-band 220 is unaffected by the interference. During time period 216 data transmission resumes because CSMA/CA no longer detects interference and thus there is transmission opportunity for the entire duration of detection interval 202 and 203. No further bandwidth downgrading is necessary. The present example employs both fast CW interference detection and direct downgrade to an unaffected bandwidth resulting in faster detection of interference and faster mitigation (i.e., faster switching to appropriate unaffected bandwidth).

FIG. 4B, included for comparison, is a timing diagram illustrating conventional interference detection and mitigation, according to some embodiments. The present disclosure outperforms conventional interference detection and mitigation under the same conditions as FIG. 4A.

For example, during detection interval 201, interference 212 is present, causing CSMA/CA to trigger a halt transmission and reception for the WLAN device. However, conventional interference detection uses different criteria to detect interference 212. For conventional interference detection, the condition to trigger bandwidth downgrade is met when the total channel idle and data transmission time in the same BSS within the detection interval is below a given percentage. TxOp is the transmission opportunity or the amount of time that the medium is idle (i.e., no transmission, reception, or interference on the medium) during a sample duration (e.g., detection interval). For example, if the time during which the WLAN device is idle, transmitting, and/or receiving is less than a threshold percentage within a sampling period (detection interval), then downgrading is triggered. However, if the total idle, transmitting, and/or receiving is more than the threshold percentage, no downgrade is triggered, and the interference persists.

In this example, a downgrade is not triggered until the end of detection interval 202 when it is determined that the WLAN device was idle, transmitting, and/or receiving for less than a threshold percentage of detection interval 202. Bandwidth downgrading finally begins at the beginning of detection interval 203. At the end of detection interval 203 interference is still detected because the WLAN device has only downgraded one bandwidth level (e.g., to 40 MHz), but the interference is present on sub-band 240. In some embodiments, downgrading one bandwidth level means downgrading to half of current bandwidth (e.g., from 80 MHz to 40 MHz or 40 MHz to 20 MHz). Thus, interference is detected again at the end of detection interval 203, and bandwidth downgrading is triggered again. At the beginning of detection interval 204, the WLAN device downgrades the operating bandwidth to 20 MHz (i.e., sub-band 220). No further interference is detected and during time period 216 data transmission resumes.

As illustrated, the no transmission opportunity period 214 of FIG. 4B is much longer than the no transmission opportunity period 214 of FIG. 4A because conventional interference detection and mitigation take longer to detect interference 212 and downgrade to the appropriate unaffected bandwidth to avoid interference 212.

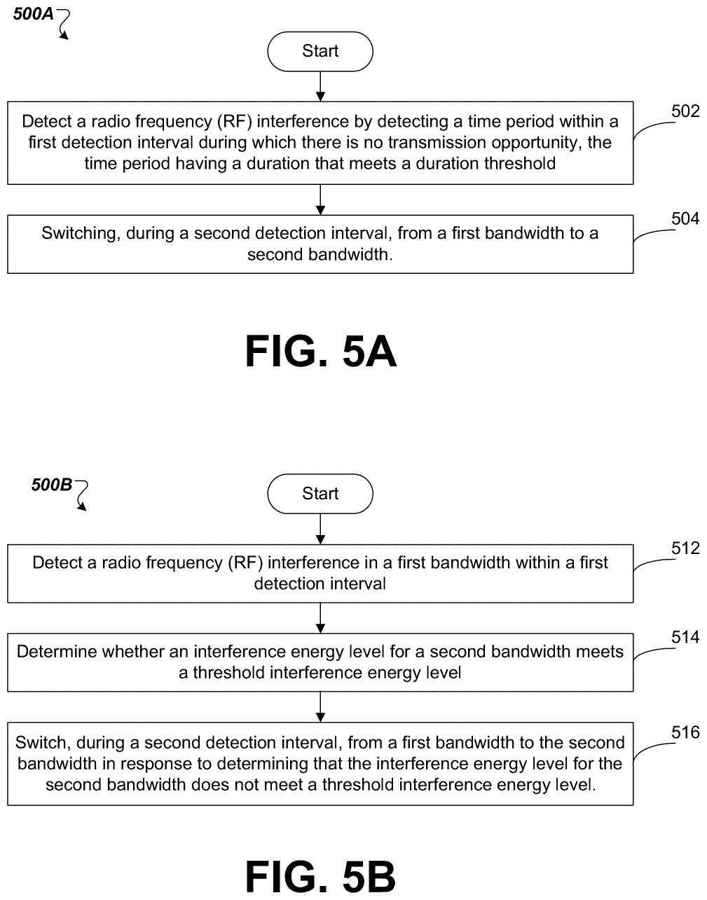

FIGS. 5A-B are flow diagrams of methods of performing CW interference detection and mitigation, according to various embodiments. The methods 500A-B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, methods 500A-B are performed by control logic and/or hardware of one of the WLAN modules of FIG. 1A or 1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

FIG. 5A is a flow diagram of a method of performing fast CW interference detection and mitigation, according to some embodiments.

Method 500A begins at block 502, where processing logic performing the method detects a RF by detecting a time period within a first detection interval during which there is no transmission opportunity, the time period having a duration that meets a duration threshold.

In some embodiments, a time period within a first detection interval during which there is no transmission opportunity refers to a time period where the channel is not idle (i.e., there is either transmit activity, receive activity, or interference). As explained below, a time period within a detection interval during which there is no transmission opportunity that meets a duration threshold typically correlates to interference rather than transmit and/or receive activity.

In some embodiments, such a time period where there is no transmission opportunity (i.e., transmission opportunity is equal to zero) correlates to CW interference being present on the channel, causing the WLAN device to stop transmitting and receiving due to CSMA/CA. When no interference is present, one consecutive period of channel busy time typically does not exceed a threshold duration (e.g., 20 percent of detection interval duration—e.g., 100 ms for a 500 ms detection interval). It should be noted that under normal operation, in the absence of interference, the total time that there is no transmission opportunity (i.e., transmission opportunity is equal to zero) during a detection interval may exceed a threshold duration. However, that total includes shorter non-consecutive time periods that are each no longer than the duration threshold and do not meet the duration threshold.

For example, the transmission or reception of a single data frame typically takes less than a threshold duration (e.g., 20 percent of detection interval duration—e.g., 100 ms for a 500 ms detection interval). Further, there are small intervals (IFSs) in between data frames where the wireless device is listening for other transmissions or other events on the channel. Therefore, even though a WLAN device may be transmitting or receiving, for example, data frames for 400 ms of a 500 ms detection interval, those 400 ms may include many shorter time periods for sending individual data frames that do not meet the duration threshold (e.g., less than 20 percent of detection interval duration—e.g., 100 ms for a 500 ms detection interval). Further, the time periods for sending data frames are interspaced with IFSs and thus the channel busy time does not exceed 20 percent of detection interval duration (e.g., 100 ms for a 500 ms detection interval) in any one period (i.e., transmission opportunity does not equal zero for more than 20 percent of detection interval duration at a time).

In some embodiments, a controller (e.g., a power save mode microcontroller in the MAC layer) may record the maximum duration that the transmission opportunity is zero within a detection interval (e.g., DBS detection interval). The controller (e.g., as a function of DBS) may check the recorded value for each detection event. In some embodiments, CW interference is detected once the duration that the transmission opportunity stays at zero exceeds a defined threshold (e.g., 20 percent of detection interval duration—e.g., 100 ms for a 500 ms detection interval).

In some embodiments, the RF interference may be a CW interference.

In some embodiments, the duration threshold is configurable. In one example, the duration threshold may be 20 percent of detection interval duration or any other percentage of a detection interval duration time e.g., 15 percent, 25 percent, etc. of a detection interval duration). In some embodiments, the duration threshold may be a fixed time duration (e.g., 100 ms, 50 ms, 20 ms, etc.).

At block 504, the processing logic switches, during a second detection interval, from a first bandwidth to a second bandwidth. In some embodiments, the first bandwidth may include a plurality of sub-bands, and the second bandwidth may include a subset of the plurality of sub-bands of the first bandwidth. For example, a WLAN device may be operating on a first bandwidth that is 80 MHz and includes sub-bands 20LL (ranging from 0 MHz to 20 MHz), 20LU (ranging from 20 MHz to 40 MHz), 20UL (ranging from 40 MHz to 60 MHz), and 20UU (ranging from 60 MHz to 80 MHz). The WLAN device may switch to a second bandwidth that is a sub-set of the sub-bands included in the original operating bandwidth, e.g., 20LU and 20LL (from 0 MHz to 40 MHz).

In some embodiments, the first and second detection intervals may be contiguous, with the first detection interval preceding the second detection interval.

In some embodiments, the processing logic may further determine whether an interference energy level for the second bandwidth meets a threshold interference energy level. In some embodiments, an energy detection (ED) is elevated in the impacted frequency sub-band where the interference is present. In some embodiments, the interference energy level meeting the threshold interference energy level means that the ED is elevated.

In some embodiments, the interference energy level for the second bandwidth may be a stored value in a register. In some embodiments, once CW interference is detected, the processing logic checks a corresponding PhyEDIndication field in the register to identify where (i.e., which frequency sub-band) the CW interference is located and downgrade to an unaffected bandwidth. For example, a register may include a PhyEDIndication or an interference energy level field where each bit in this field corresponds to a 20 MHz sub-band and operating bandwidth for which the physical layer (PHY) is providing the PhyEDIndication or interference energy level indication. In some embodiments, reading back a 1 in this field indicates that the PHY has asserted the PhyEDIndication or interference energy level for that corresponding 20 MHz sub-band meets the threshold interference energy level.

In some embodiments, the processing logic may refer to a register (e.g., an existing hardware register) to identify where CW interference is located.

In some embodiments, the processing logic may determine if a frequency sub-band has an elevated interference energy level as well as which sub-bands do not have an elevated interference energy level. The processing logic may downgrade the operation of the RF circuitry to a sub-band without an elevated interference energy level that is below the sub-band with the elevated interference energy level.

In some embodiments, interference is detected during the detection interval. The processing logic may determine, by checking a register where interference energy levels are stored, which sub-bands have an elevated interference energy level. In some embodiments, the processing logic may also determine which sub-bands do not have elevated interference energy levels by checking a register where interference energy levels are stored.

In response to determining that the interference energy level for the second bandwidth does not meet the threshold interference energy level, the processing device may switch, during the second detection interval, from the first bandwidth to the second bandwidth. In some embodiments, the second bandwidth may include multiple sub-bands (e.g., 20 MHz and 40 MHz). In some embodiments, determining that the interference energy level for the second bandwidth does not meet the threshold interference energy level includes determining that the interference energy level for each sub-band of the second bandwidth does not meet the threshold interference energy level.

FIG. 5B is a flow diagram of a method of performing interference detection and mitigation by directly downgrading to an unaffected bandwidth, according to some embodiments.

Method 500B begins at block 512, where processing logic performing the method detects an RF interference in a first bandwidth within a first detection interval. In some embodiments, the first bandwidth is the operating bandwidth of a WLAN device. In some embodiments, the RF interference is a CW interference.

At block 514, the processing logic determines whether an interference energy level for a second bandwidth meets a threshold interference energy level. In some embodiments, the first bandwidth comprises a plurality of sub-bands, and the second bandwidth comprises a subset of the plurality of sub-bands of the first bandwidth. For example, a WLAN device may be operating on a first bandwidth that is 80 MHz and includes sub-bands 20LL (ranging from 0 MHz to 20 MHz), 20LU (ranging from 20 MHz to 40 MHz), 20UL (ranging from 40 MHz to 60 MHz), and 20UU (ranging from 60 MHz to 80 MHz). The WLAN device may switch to a second bandwidth that is a sub-set of the sub-bands included in the original operating bandwidth, e.g., 20LU and 20LL (from 0 MHz to 40 MHz).

In some embodiments, an energy detection (ED) is elevated in the impacted frequency sub-band where the interference is present. In some embodiments, the interference energy level meeting the threshold interference energy level means that the ED is elevated (i.e., interference is present on the sub-band). In some embodiments, the interference energy level for the second bandwidth is a stored value in a register. In some embodiments, once CW interference is detected, the processing logic checks a corresponding PhyEDIndication field in the register to identify where (i.e., which frequency sub-band) the CW interference is located and downgrade to an unaffected bandwidth. For example, a register may include a PhyEDIndication or an interference energy level field where each bit in this field corresponds to a 20 MHz sub-band and operating bandwidth for which the physical layer (PHY) is providing the PhyEDIndication or interference energy level indication. In some embodiments, reading back a 1 in this field indicates that the PHY has asserted the PhyEDIndication or interference energy level for that corresponding 20 MHz sub-band meets the threshold interference energy level. In some embodiments, reading back a 0 in this field indicates that the PHY has not asserted the PhyEDIndication or interference energy level for that corresponding 20 MHz sub-band does not meet the threshold interference energy level.

In some embodiments, the processing logic may determine if a frequency sub-band has an elevated interference energy level as well as which sub-bands do not have an elevated interference energy level. The processing logic may downgrade the operation of the RF circuitry to a sub-band without an elevated interference energy level that is below the sub-band with the elevated interference energy level.

In some embodiments, interference is detected during the detection interval. The processing logic may determine, by checking a register where interference energy levels are stored, which sub-bands have an elevated interference energy level. In some embodiments, the processing logic may also determine which sub-bands do not have elevated interference energy levels by checking a register where interference energy levels are stored.

At block 516, the processing logic switches, during a second detection interval, from a first bandwidth to the second bandwidth in response to determining that the interference energy level for the second bandwidth does not meet the threshold interference energy level (i.e., interference is not present in the second bandwidth). In some embodiments, the first and second detection intervals are contiguous, with the first detection interval preceding the second detection interval.

In some embodiments, the detecting an RF interference in a first bandwidth within a first detection interval comprises detecting a time period within the first detection interval during which there is no transmission opportunity, the time period having a duration that meets a duration threshold. As explained below, a time period within a detection interval during which there is no transmission opportunity that meets a duration threshold typically correlates to interference rather than transmit and/or receive activity.

In some embodiments, such a time period where there is no transmission opportunity (i.e., transmission opportunity is equal to zero) correlates to CW interference being present on the channel, causing the WLAN device to stop transmitting and receiving due to CSMA/CA. When no interference is present, one consecutive period of channel busy time typically does not exceed a threshold duration (e.g., 20 percent of detection interval duration—e.g., 100 ms for a 500 ms detection interval). Periods of no transmission opportunity (i.e., transmission opportunity is equal to zero) may be referred to as channel busy time (i.e., when the WLAN device is neither transmitting, receiving, nor being interfered with). It should be noted that under normal operation, in the absence of interference, the total time that there is no transmission opportunity (i.e., transmission opportunity is equal to zero) during a detection interval may exceed a threshold duration. However, that total includes shorter non-consecutive time periods that are each no longer than the duration threshold and do not meet the duration threshold.

For example, the transmission or reception of a single data frame typically takes less than a threshold duration (e.g., 20 percent of detection interval duration—e.g., 100 ms for a 500 ms detection interval). Further, there are small intervals (IFSs) in between data frames where the wireless device is listening for other transmissions or other events on the channel. Therefore, even though a WLAN device may be transmitting or receiving, for example, data frames for 400 ms of a 500 ms detection interval, those 400 ms may include many shorter time periods for sending individual data frames that do not meet the duration threshold (e.g., less than 20 percent of detection interval duration). Further, the time periods for sending data frames are interspaced with IFSs and thus the channel busy time does not exceed 20 percent of detection interval duration in any one period (i.e., transmission opportunity does not equal zero for more than 20 percent of detection interval duration at a time).

It will be apparent to one skilled in the art that at least some embodiments may be practiced without these specific details. In other instances, well-known components, elements, or methods are not described in detail or are presented in a simple block diagram format in order to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non-transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like). The non-transitory computer-readable storage medium may include, but is not limited to, electromagnetic storage medium, read-only memory (ROM), random-access memory (RAM), erasable programmable memory (e.g., EPROM and EEPROM), flash memory, or another now-known or later-developed non-transitory type of medium that is suitable for storing information.

Although the operations of the circuit(s) and block(s) herein are shown and described in a particular order, in some embodiments, the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method comprising:
detecting a radio frequency (RF) interference by detecting a time period within a first detection interval during which there is no transmission opportunity, the time period having a duration that meets a duration threshold; and
switching, during a second detection interval, from a first bandwidth to a second bandwidth.

2. The method of claim 1, wherein the first and second detection intervals are contiguous, the first detection interval preceding the second detection interval.

3. The method of claim 1, further comprising:
determining whether an interference energy level for the second bandwidth meets a threshold interference energy level; and
in response to determining that the interference energy level for the second bandwidth does not meet the threshold interference energy level, switching, during the second detection interval, from the first bandwidth to the second bandwidth.

4. The method of claim 1, wherein the first bandwidth comprises a plurality of sub-bands and the second bandwidth comprises a subset of the plurality of sub-bands of the first bandwidth.

5. The method of claim 3, wherein the interference energy level for the second bandwidth is a stored value in a register.

6. The method of claim 1, wherein the RF interference is a continuous wave (CW) interference.

7. A method comprising:
detecting a radio frequency (RF) interference in a first bandwidth within a first detection interval;
determining whether an interference energy level for a second bandwidth meets a threshold interference energy level; and
switching, during a second detection interval, from a first bandwidth to the second bandwidth in response to determining that the interference energy level for the second bandwidth does not meet the threshold interference energy level.

8. The method of claim 7, wherein the first and second detection intervals are contiguous, the first detection interval preceding the second detection interval.

9. The method of claim 7, wherein the first bandwidth comprises a plurality of sub-bands and the second bandwidth comprises a subset of the plurality of sub-bands of the first bandwidth.

10. The method of claim 7, wherein the detecting an RF interference in a first bandwidth within a first detection interval comprises detecting a time period within the first detection interval during which there is no transmission opportunity, the time period having a duration that meets a duration threshold.

11. The method of claim 7, wherein the interference energy level for the second bandwidth is a stored value in a register.

12. The method of claim 7, wherein the RF interference is a continuous wave (CW) interference.

13. A system comprising:
a wireless module comprising radio frequency (RF) circuitry, wherein the wireless module is to detect an RF interference by detecting a time period within a first detection interval during which there is no transmission opportunity, the time period having a duration that meets a duration threshold, while the RF circuitry operates on a first bandwidth; and
a processing device coupled to the RF circuitry, wherein the processing device is to switch the RF circuitry from operating with a first bandwidth to a second bandwidth during a second detection interval.

14. The system of claim 13, wherein the first and second detection intervals are contiguous, the first detection interval preceding the second detection interval.

15. The system of claim 13, wherein the processing device is further to:
determine whether an interference energy level for the second bandwidth meets a threshold interference energy level; and
in response to determining that the interference energy level for the second bandwidth does not meet the threshold interference energy level, switch, during the second detection interval, from the first bandwidth to the second bandwidth.

16. The system of claim 13, wherein the first bandwidth comprises a plurality of sub-bands and the second bandwidth comprises a subset of the plurality of sub-bands of the first bandwidth.

17. The system of claim 15, wherein the interference energy level for the second bandwidth is a stored value in a register.

18. The system of claim 13, wherein the wireless module is a wireless local area network (WLAN) module.

19. The system of claim 13, wherein the processing device comprises firmware, wherein the firmware is to:
switch the RF circuitry from operating with a first bandwidth to a second bandwidth during a second detection interval.

20. The system of claim 13, wherein the RF interference is a continuous wave (CW) interference.
